(19) United States
(12) Patent Application Publication
(10) Pub. No.: US 2026/0331453 A1
(43) Pub. Date: Oct. 22, 2026

(54) LASER-SUSTAINED PLASMA LIGHT SOURCE WITH COUNTER-PROPAGATING PUMP BEAM CONFIGURATION

(71) Applicant: KLA Corporation, Milpitas, CA (US)

(72) Inventors: Yuka ESASHI, Singapore (SG); Boon Leng CHUAH, Singapore (SG); Cheng TANG, Singapore (SG); Rui ZHOU, Singapore (SG); Dongxia HOU, Singapore (SG); Jinfa HO, Singapore (SG); ZhongWei JIANG, Singapore (SG)

(21) Appl. No.: 19/376,287

(22) Filed: Oct. 31, 2025

Related U.S. Application Data
(60) Provisional application No. 63/790,030, filed on Apr. 17, 2025.

(51) Int. Cl. H01J 61/02; G02B 19/00; G02B 27/28; H01J 65/00

(52) U.S. Cl. CPC H01J 61/025; G02B 19/0019; G02B 19/0047; G02B 27/283; H01J 65/00

(57) ABSTRACT

A laser-sustained broadband light source with counter-propagating pump beam configuration is disclosed. The light source includes a gas vessel for gas containment, a pump source generating a pump beam, and a pump optical assembly with a polarization element that splits the pump beam into two beams with orthogonal polarization states. These beams are focused into the gas vessel from opposite directions, with overlapping focal regions sustaining a plasma. A collection optical assembly collects broadband light emitted from the plasma. This configuration increases the numerical aperture (NA) of pumping, enhances plasma radiance, and maintains a compact footprint. Principal uses include semiconductor metrology, inspection tools, and optical characterization systems requiring high-brightness broadband light sources.

### CROSS-REFERENCE TO RELATED APPLICATION

The present application claims priority to United States Provisional Application Serial No. 63/790,030, filed Apr. 17, 2025, which is incorporated herein by reference in their entirety.

### TECHNICAL FIELD

The present disclosure generally relates to laser-sustained plasma (LSP) light sources, and, more particularly, to systems and methods for enhancing the brightness and radiance of LSP sources utilized in semiconductor metrology and inspection tools.

### BACKGROUND

Laser-sustained plasma (LSP) light sources are widely used in broadband inspection tools for use in semiconductor inspection and imaging and there is growing demand for increasing the brightness of these light sources LSP sources operate by focusing a laser beam into a pressure vessel containing a gas medium. A plasma is then ignited inside the gas medium by some method, for example an electrical discharge or a pulsed laser. The plasma is then sustained (“pumped”) by the focused laser beam. The radiation emitted from the plasma provides bright incoherent broadband light suitable for various semiconductor metrology and inspection techniques.

One approach to increasing the radiance of an LSP source is to increase the plasma temperature by using a higher pump laser power. However, past a certain point, most of the pump laser light is absorbed by the periphery of the plasma, and there is only a little or no increase of the pump power reaching the plasma core; therefore, increasing the pump laser power merely increases the size of the plasma and not the plasma core temperature. As a result, radiance of an LSP source tends to saturate at high pump powers.

Another approach to increasing the radiance of an LSP source is to increase the numerical aperture (NA) of the pump laser beam. This ensures that the laser intensity only surpasses the critical threshold for plasma sustainment in a small volume around the beam focus, thereby ensuring that the plasma size stays small. This reduces the absorption of the pump laser by the plasma periphery and increases the pump laser intensity at the plasma core.

Beyond increasing the NA of the focusing lens used on the pumping illumination, one method of achieving high NA pumping in an LSP source involves pumping the plasma from all around the gas vessel by placing the vessel at one focus of a concave reflective focusing optic, such as an ellipsoidal or a parabolic mirror [US 2007/0228288 A1 2007 Smith, US 10504714 B2 2019 Blondia et al.]. While this method can achieve an extremely high NA, the collection of the plasma radiation must usually be done collinearly with the pump beam. This is often done using a wavelength-filtering optic that is transparent to the pumping laser wavelength but is reflective to the wavelength range of interest for collection, or vice versa. This limits the use of this method to cases where the wavelength range of interest does not overlap with the pump wavelength.

Another method of achieving high NA pumping is to re-direct the pump beam’s left-over power after its transmission through the plasma back into the gas vessel from a different angle [US 11778720 B2 2023 Derstine et al.]. This method makes an efficient use of the otherwise unused portion of the pump laser power and increases the total power absorbed by the plasma, at the same time increasing the total effective NA of the pumping beams. This method also often still reserves space for non-collinear collection of the plasma radiation. However, it is an inefficient way of increasing the NA as most of the laser power directed at the plasma is still contained within the first pass of the pump beam. Therefore, the plasma volume may still extend towards the incoming direction of the laser’s first pass, resulting in saturation of the plasma radiance at high pump laser powers. In addition, since the pump laser intensity distribution is non-symmetric within the gas vessel, the sustained plasma shape also tends to be non-symmetric in shape, which could potentially cause instabilities due to the uneven convective gas flow around the plasma. The left-over beam also usually has a degraded beam profile after passing through the plasma, and re-direction of such a degraded beam back into the plasma could contribute to further instability.

Yet another method of increasing the pumping laser NA is simply to increase the number of pump laser beams and to direct them into the gas vessel from multiple angles [US 10714327 B2 2020 Bezel et al.]. This method, however, has many components that must be placed near the gas vessel (focusing optics for each pump beam; receiving optics for each pump beam to safely manage any left-over beam unabsorbed by the plasma; and plasma radiation collection optics). This can cause an increase in the footprint of the light source, and/or place restrictions on the design of the optics used. This is also true for the previous method where the left-over power is re-directed into the gas vessel after its first pass.

Previous approaches suffer from (1) limited range of wavelengths collectable from the plasma radiation; (2) inefficiency in increasing NA; (3) asymmetry of plasma shape due to asymmetrical pumping; and (4) the increased footprint of the light source.

Therefore, it is desirable to provide a system and broadband LSP source that overcomes the limitations of the previous approaches.

### SUMMARY

A laser-sustained broadband light source is disclosed. In some aspects, the light source includes a gas vessel configured to contain a gas. In some aspects, the light source includes a pump source configured to generate a pump beam. In some aspects, the light source includes a pump optical assembly. In some aspects, the pump optical assembly includes a polarization element configured to split the pump beam into a first beam having a first polarization state and a second beam having a second polarization state orthogonal to the first polarization state. In some aspects, the pump optical assembly includes one or more optical elements configured to focus the first beam into the gas vessel along a first propagation direction, and to focus the second beam into the gas vessel along a second propagation direction opposite the first propagation direction, with focal regions of the first and second beams at least partially overlapping within the gas vessel to sustain the plasma. In some aspects, the light source includes a collection optical assembly configured to collect at least a portion of broadband light emitted from the plasma.

A characterization system is disclosed. In some aspects, the characterization system includes a laser-sustained light source. In some aspects, the laser-sustained light source includes a gas vessel configured to contain a gas. In some aspects, the laser-sustained light source includes a pump source configured to generate a pump beam. In some aspects, the laser-sustained light source includes a pump optical assembly. In some aspects, the pump optical assembly includes a polarization element configured to split the pump beam into a first beam having a first polarization state and a second beam having a second polarization state orthogonal to the first polarization state. In some aspects, the pump optical assembly includes one or more optical elements configured to focus the first beam into the gas vessel along a first propagation direction, and to focus the second beam into the gas vessel along a second propagation direction opposite the first propagation direction, with focal regions of the first and second beams at least partially overlapping within the gas vessel to sustain the plasma. In some aspects, the laser-sustained light source includes a collection optical assembly configured to collect at least a portion of broadband light emitted from the plasma. In some aspects, the characterization system further includes a set of illumination optics configured to direct broadband light from the laser-sustained light source to one or more samples. In some aspects, the characterization system includes a set of collection optics configured to collect light emanating from the one or more samples. In some aspects, the characterization system includes a detector assembly.

A method for generating broadband light is disclosed. In some aspects, the method includes providing a gas vessel configured to contain a gas. In some aspects, the method includes generating a pump beam. In some aspects, the method includes splitting the pump beam, using a polarization element, into a first beam having a first polarization state and a second beam having a second polarization state orthogonal to the first polarization state. In some aspects, the method includes focusing the first beam into the gas vessel along a first propagation direction. In some aspects, the method includes focusing the second beam into the gas vessel along a second propagation direction opposite the first propagation direction. In some aspects, the method includes at least partially overlapping the focal regions of the first and second beams within the gas vessel to sustain a plasma. In some aspects, the method includes collecting at least a portion of broadband light emitted from the plasma.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

The numerous advantages of the disclosure may be better understood by those skilled in the art by reference to the accompanying figures.

FIGS. 1A-1B illustrate a broadband LSP light source, in accordance with one or more embodiments of the present disclosure.

FIG. 1C illustrates an asymmetric plasma shape within the gas vessel resulting from a single-direction pump beam configuration.

FIG. 1D illustrates a symmetric and more compact plasma shape within the gas vessel achieved by counter-propagating pump beams of balanced power.

FIG. 1E shows an experimental image of the plasma formed in the gas vessel using a single-direction pump beam configuration

FIG. 1F shows an experimental image of the plasma formed in the gas vessel using counter-propagating pump beams of balanced power, demonstrating a symmetric and more compact plasma shape.

FIG. 2A illustrates a simplified schematic view of a broadband LSP light featuring a counter-propagating pump beam configuration with a polarization element and overlapping focal regions within the gas vessel, in accordance with one or more embodiments of the present disclosure.

FIG. 2B illustrates a simplified schematic view of a broadband LSP light featuring a counter-propagating pump beam configuration with a non-polarizing beam splitting element, in accordance with one or more additional and/or alternative embodiments of the present disclosure.

FIG. 3 illustrates experimental data demonstrating the effect of symmetric versus asymmetric pumping configurations on plasma radiance as pump laser power is increased, in accordance with one or more embodiments of the present disclosure.

FIG. 4A illustrates alignment optics used to adjust the relative positions of the two pump beams, allowing control over the plasma shape and behavior, in accordance with one or more embodiments of the present disclosure.

FIG. 4B and FIG. 4C illustrate images showing plasma shapes optimized for maximum radiance and for an enlarged uniform region, respectively, in accordance with one or more embodiments of the present disclosure.

FIG. 5 illustrates a simplified schematic view of the LSP broadband source with focusing and shaping optics positioned upstream of the polarization element, enabling shared use by both pump beams to reduce system cost and footprint, in accordance with one or more embodiments of the present disclosure.

FIG. 6 illustrates a simplified schematic view of an LSP broadband light source including duplicated optical assemblies to produce two pairs of symmetrical pump beams, in accordance with one or more embodiments of the present disclosure.

FIG. 7 illustrates a simplified schematic view of an LSP broadband light source including an optical arrangement for splitting a single pump beam into multiple arms by additional polarization manipulation to produce two pairs of symmetrical pump beams, in accordance with one or more embodiments of the present disclosure.

FIG. 8 illustrates a simplified schematic view of an optical characterization system incorporating the LSP broadband light source, in accordance with one or more embodiments of the present disclosure.

### DETAILED DESCRIPTION

Reference will now be made in detail to the subject matter disclosed, which is illustrated in the accompanying drawings. The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure.

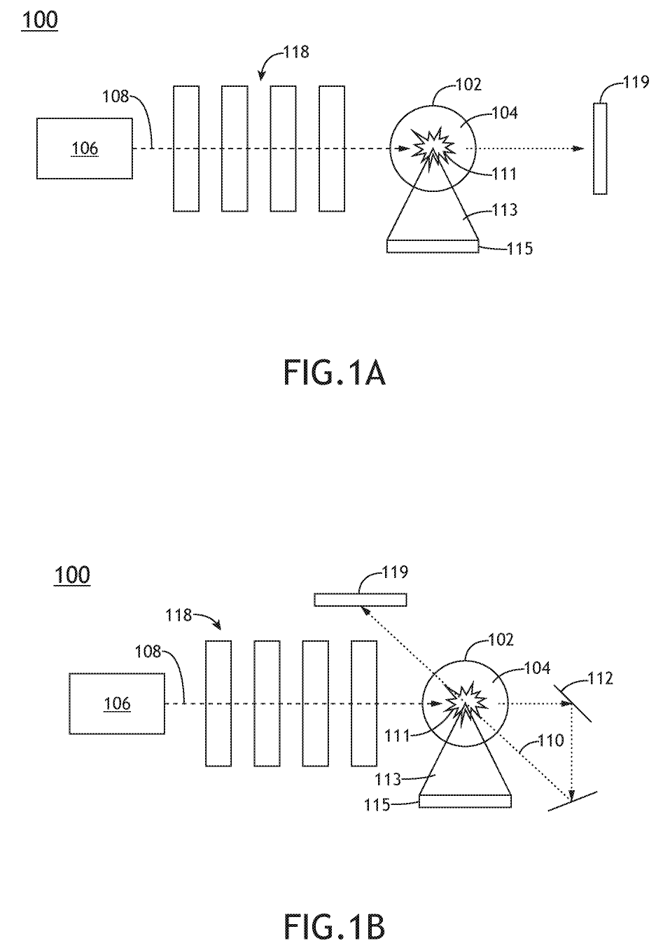

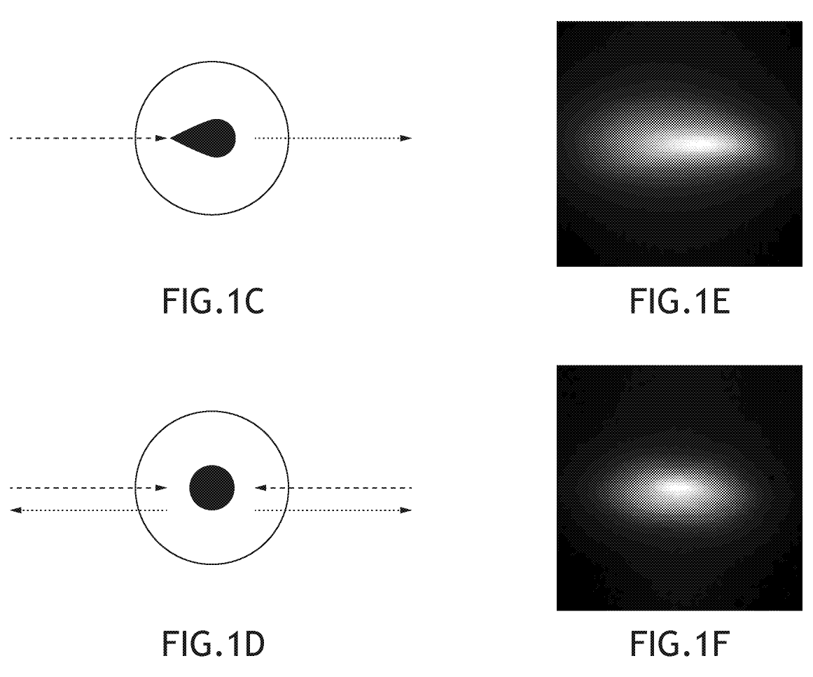

.FIGS. 1A-1B illustrate typical setups employed in an LSP source. In embodiments, the LSP source 100 includes a configuration where the pump beam 108 is directed, via one or more shaping and focusing optics 118, to the gas vessel 102 from the pump source 106 in a given direction, and where the plasma radiation 113 is collected non-collinearly with respect to the pump beam by a collection optic 115.

FIG. 1A illustrates the LSP source 100 where there is a single pump beam. In this case, the beam 108 passes through a series of focusing and shaping optics 118, and the beam focus is placed inside the gas vessel 102 containing the gas volume 104. The beam sustains the plasma around its focus and then exits the gas vessel onto a beam block. The plasma radiation 113 is collected at an angle away from the pump beam 108 with the leftover pump beam collected by the beam block 119. An LSP source configuration similar to the arrangement of FIG. 1A is disclosed in U.S. Patent No. 10,032,619 B2 to Chuang et al., issued on Jul. 24, 2018, which is incorporated by reference in the entirely. FIG. 1B illustrates a variation of the LSP source 100, where the remaining pump beam, after the first pass through the plasma 111, is re-directed into the gas vessel 102 and is then collected on a beam block 119. The left-over beam may be re-directed back into the plasma 111 multiple times before being collected on the beam block 119. It is noted that the configurations of FIG. 1A and 1B have all or majority of the pump laser power in the first pass of the beam 108 through the gas vessel 102.

The previous approaches illustrated in FIGS. 1A and 1B have most of the pump beam 108 entering the gas vessel 102 from one direction. This causes the plasma 111 to be asymmetric in shape within the gas vessel 102, as the plasma 111 grows towards the incoming direction of the pump beam 108. This effect is illustrated in FIG. 1C, with the corresponding experimental image of the plasma illustrated in FIG. 1E. Such a configuration can result in saturation of the plasma radiance for high pump laser powers, and potentially instability of the plasma due to the uneven convective gas flow around the plasma.

In embodiments of this disclosure, two pump beams enter the gas vessel in a symmetric manner with balanced power. As a result, the sustained plasma will take a symmetric and a more compact shape, as illustrated in FIG. 1D and corresponding experimental image FIG. 1F. Embodiments of the present disclosure mitigate saturation of plasma radiance until higher laser powers than the setup described in FIG. 1C, and result in a hotter and brighter plasma. Smaller plasma also allows that, for a given etendue of a system, the plasma radiation can be collected from a wider solid angle, which allows for a higher collected usable power. The symmetric shape of the plasma could also induce a more stable convective gas flow around the plasma and reduce the plasma noise.

Embodiments of the present disclosure are directed to a broadband LSP light source that increases the NA of the pump illumination beyond simply increasing the NA of the refractive optic used to focus the beam into the gas vessel. Other approaches to increase the NA of the pump beam either re-direct the left-over pump beam after its first pass through the plasma or simply increases the number of pump beams entering the gas vessel. These approaches need a larger number of optics to be placed closely around the gas vessel, as each beam requires a set of focusing and shaping optics before entering the gas vessel, as well as collection optics and beam blocks after leaving the gas vessel. This high demand for space around the gas vessel may place restrictions on the design of the focusing optics for the pump illumination or the collection optics for the plasma radiation. In contrast, embodiments of the present disclosure propagate two pump beams in a counter-propagating manner, thereby utilizing the focusing optics of one of the arms as the collection optics of the other. This approach achieves high NA pumping in a relatively compact footprint, without compromising on the design of optics used on each pumping arm, and at the same time safely managing any of the left-over pump beam after transmission through the plasma away from the gas vessel. That the left-over pump beams can be dealt with by a single beam block away from the gas vessel is an important advantage, as LSP light sources often suffer thermal management issues due to the high power of the pump laser as well as the plasma radiation. The broadband LSP light source of the present disclosure provides multiple advantages over other previous approaches such as, but not limited to, improved light source footprint and stability.

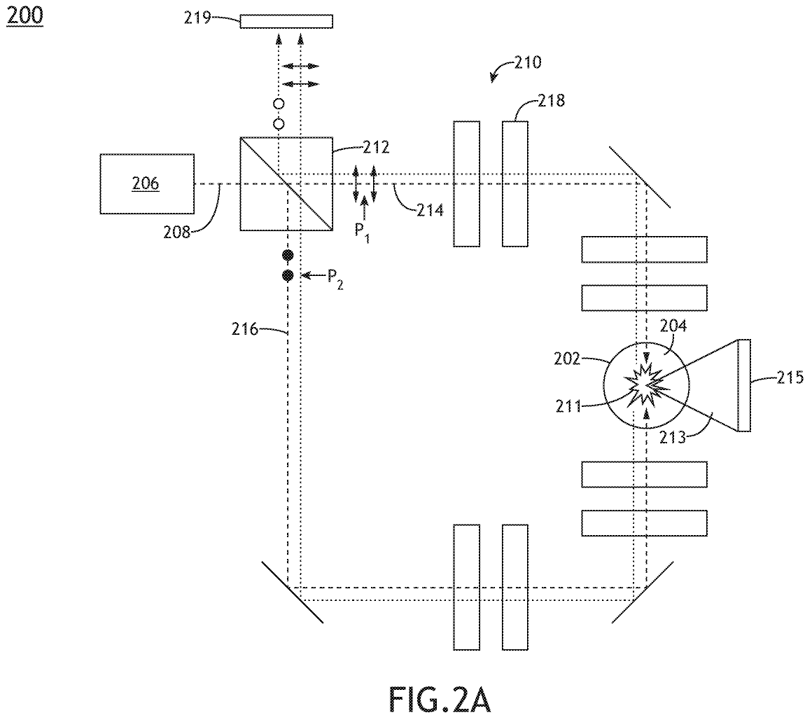

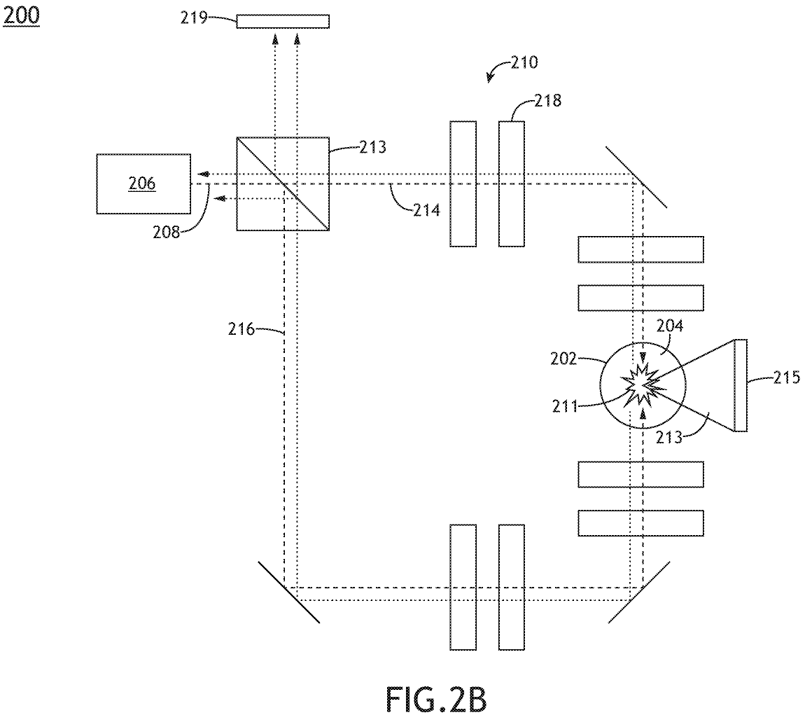

FIG. 2A illustrates the LSP broadband light source 200, in accordance with one or more embodiments of the present disclosure. In embodiments, the broadband light source 200 includes a gas vessel 202 configured to contain a gas 204. In embodiments, the light source 200 includes a pump source 206 (e.g., continuous wave (CW) laser) configured to generate a pump beam 208 and a pump optical assembly 210 configured to focus and shape the pump beam 208 into the gas vessel 202 to sustain a plasma 211 within the gas vessel 202. In embodiments, the pump optical assembly 210 includes a polarization element 212 configured to split the pump beam into a first beam 214 having a first polarization, P₁, and a second beam 216 having a second polarization, P₂, orthogonal to the first polarization. The first beam 214 and the second beam 216 may have the same or similar intensities. For example, the first beam 214 and the second beam 216 may have intensities that are within 0-20% of each other. For instance, of the sum intensity levels from the first beam 214 and the second beam 216, the distribution of the sum intensity may include a 50/50 intensity distribution, 55-45 intensity distribution, or 40-60 intensity distribution.

The pump optical assembly 210 may include one or more optical elements 218 (e.g., lenses, mirrors, and the like) configured to focus the first beam 214 and the second beam 216 into the gas vessel 202 from opposite directions. In embodiments, the LSP broadband light source 200 includes a light collector element 215 (e.g., one or more mirrors and/or one or more lenses) configured to collect at least a portion of broadband light 213 emitted from the plasma 211. The light collector element 215 may include a reflector assembly such as, but not limited to, an off-axis reflector assembly configured to collect broadband light from the plasma at a non-collinear angle relative to the pump beam 208. In alternative and/or additional embodiments, the light collector element 215 may include an elliptical reflector assembly and/or a spherical reflector assembly.

As shown in FIG. 2A, in embodiments, the pump beam is first split into two arms, with orthogonal polarization states P1, P2 and relatively similar intensities, by a polarization element 212, such as, but not limited to, a polarizing beam splitter. The initial pump beam 208 may be configured in or close to a polarization state that allows this near-even splitting. For example, the initial pump beam 208 may be linear ±45° polarized, circularly polarized, or unpolarized. Then, the two arms are independently passed through a series of focusing and shaping optics 218 and are focused into the gas vessel 202 from two opposing directions. After passing through the plasma 211 once, the two beams trace the path of the other beam in reverse and again reach the polarization element 212. Given the polarized state of each of the beams and the entrance direction of the beams into the polarization element 212, the returned beams do not return to the pump source 206 but instead are diverted into different directions to be safely collected on a beam block 219. In this regard, a left-over pump beam from a first arm, after transmission through the plasma 211, may trace the one or more optical elements 218 of a second arm in reverse, and are diverted away from the pump source 206 at the polarization element 212. The beam block 219 may be positioned to receive the first pump beam and the second pump beam diverted by the polarization element 212.

It is noted that by splitting the pump beam into two arms of similar intensities, the configuration of the present disclosure provides doubling of the total effective NA of the pumping illumination. This configuration ensures that the laser intensity is high only around the center of the gas vessel 202 where the two foci of the pump beams 214, 216 coincide. Such an arrangement aids in maintaining a small plasma volume and mitigates saturation of the plasma 211 radiance at high pump laser powers.

It is noted that the optical configuration of system 200 is not limited to a polarization element and the polarizing splitting element of FIG. 2A may be replaced with a non-polarizing optical element. In additional and/or alternative embodiments, as shown in FIG. 2B, the system 200 may include a non-polarizing optical splitting element. For example, the system 200 may include a non-polarizing beam splitter 213 configured to spit the initial beam 208 into perpendicular paths, as discussed previously herein. Then, each returning beam will be split into two perpendicular paths at the non-polarizing beam splitter 213. In this regard, one returning beam will be blocked by one or more beam blocks 219, while the other returning beam will be directing back into the pump laser source 206, which may be engineered to isolate the returning beam from one or more components of the pump laser source 206.

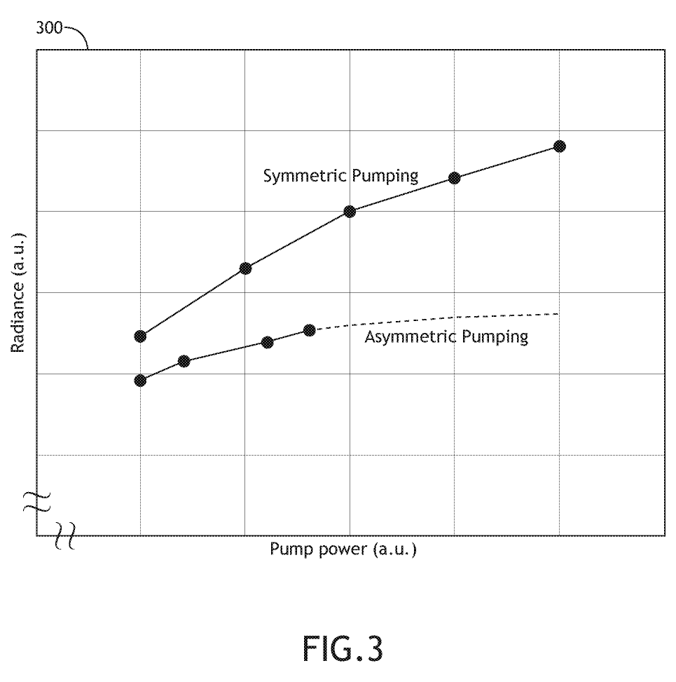

FIG. 3 illustrates experimental data 300 demonstrating the effect of the arrangement of LSP broadband light source 200. It is noted that, as pump laser power is increased, a system with an asymmetric pumping configuration (such as shown in FIG. 1) saturates in radiance. However, a system with a symmetric pumping configuration (as shown in FIG. 2) continues to increase in radiance without suffering saturation effects.

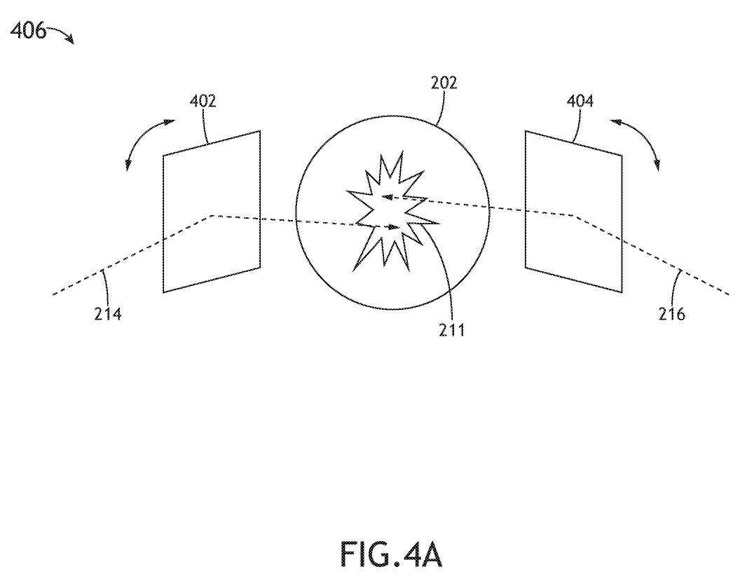

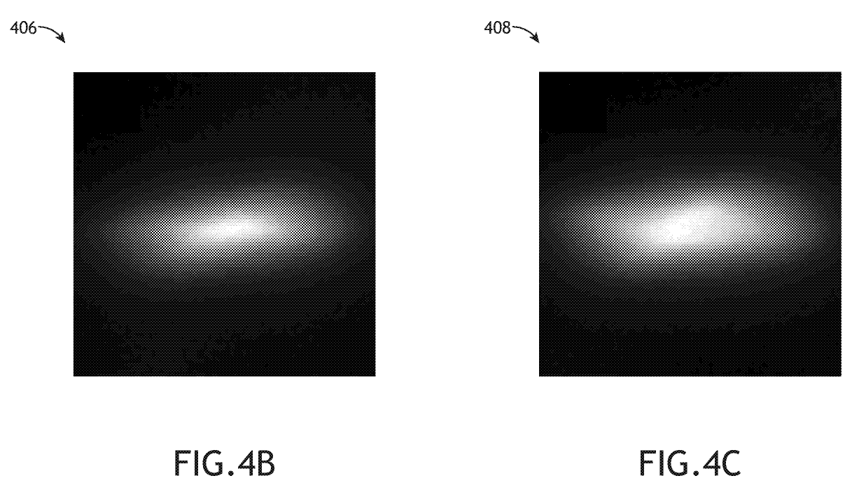

In embodiments, as shown in FIG. 4A, the LSP broadband light source 200 may be configured to such that the alignment of the first beam 214 and the second beam 216 is adjustable to control a shape and/or other behavior of the plasma 211. In embodiments, alignment optics 402, 404 (e.g., mirrors) may be utilized to direct the two beams 214, 216 into the gas vessel 202. In this regard, the alignment optics 402, 404 may place the foci of the two pump 214, 216 at slightly shifted positions relative to each other. Such a configuration allows the plasma shape to be optimized according to the specific application. Plasma shaping is generally discussed in U.S. Patent 11,778,720 to Derstine et al., issued on Oct 3, 2023, which is incorporated herein by reference in the entirety. In embodiments, the alignment optics 402, 404 may be utilized to maximize radiance. For example, the plasma volume can be intentionally decreased to have a smaller center region with high uniformity in order to increase the overall radiance of the plasma. In alternative and/or additional embodiments, the alignment optics 402, 404 may be used to enlarge the uniform region of the plasma at the center of the plasma 211. For example, the plasma volume can be intentionally increased to have a larger center region with high uniformity, at the cost of slightly reducing the overall radiance of the plasma. FIG. 4B illustrates an image 406 showing the case where alignment optics 402, 404 are utilized to maximize radiance. FIG. 4C illustrates an image 408 showing the case where alignment optics 402, 404 are utilized to achieve an enlarged uniform region at the center of the plasma 211.

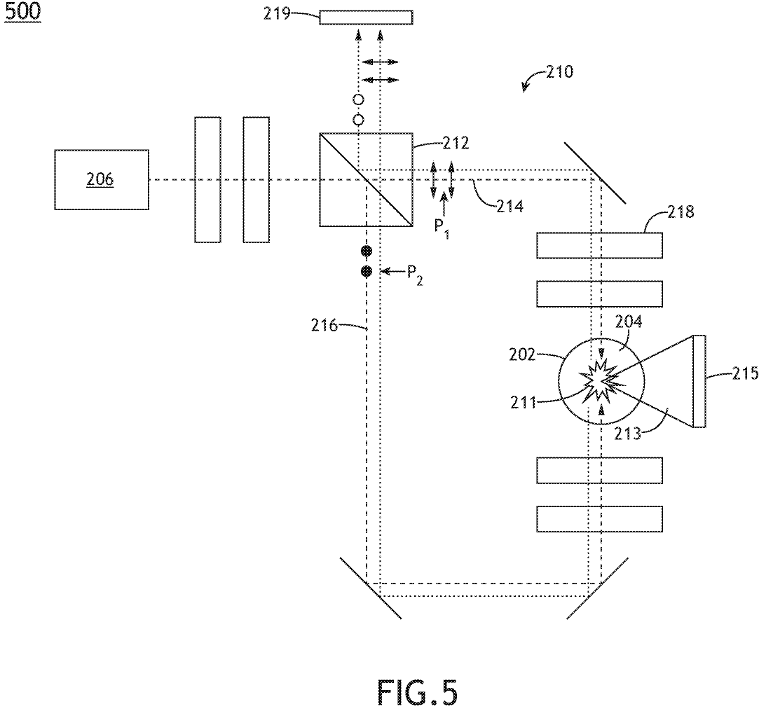

FIG. 5 illustrates the LSP broadband source, in accordance with an additional and/or alternative embodiment of the present disclosure. In this embodiment, some of the focusing and shaping optics 218 for the pump beam 208 are placed before the polarization element 212. In this regard, focusing and shaping optics positioned prior to the polarization element 212 are shared by the two pump beams 214, 216 emanating out of the polarization element 212. Placement of some or all of the focusing/shaping optics upstream of the polarization element allows reduction of the cost and the footprint of the components of the LSP broadband source 200.

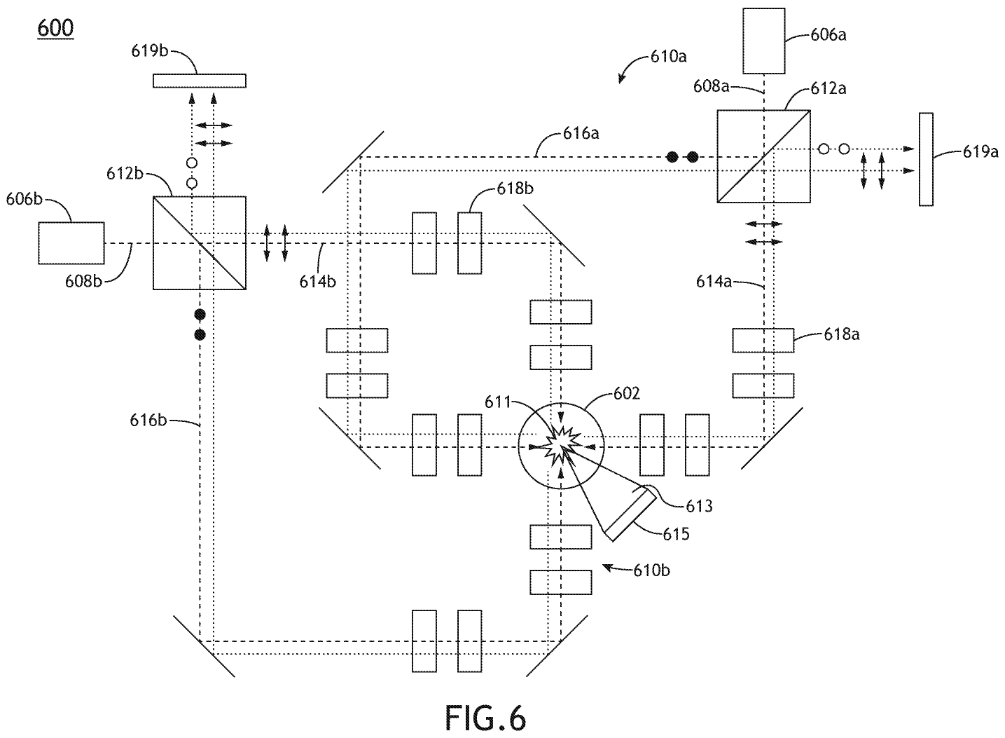

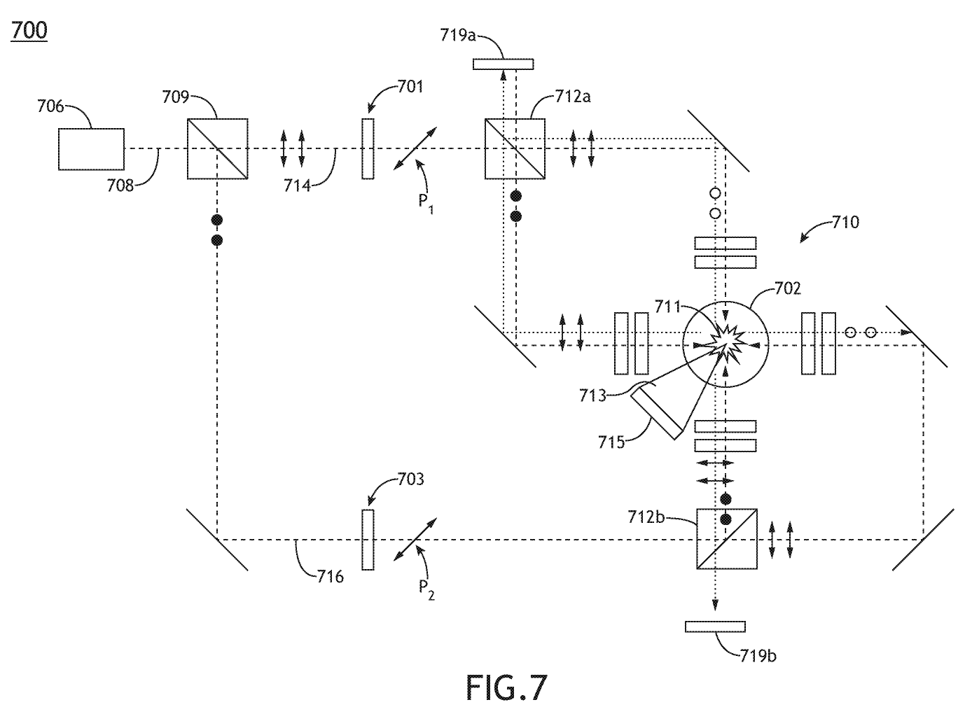

FIGS. 6 and 7 illustrate LSP broadband light sources 600, 700 configured to include two pairs of symmetrically pumping beams. While FIGS. 6 and 7 illustrate cases where the number of pair of pump beams have been increased from one to two, the number can be increased further as needed.

FIG. 6 illustrates system 600 including two pairs of symmetrical pump beams, in accordance with one or more embodiments of the present disclosure. In this embodiment, the number of pump beam pairs is increased to two by duplicating the LSP broadband light source 200, described previously herein, around the gas vessel. In this example, an optical assembly, such as that shown in LSP broadband light source 200, is duplicated around a common gas vessel 602 to enable multiple pairs of orthogonally polarized beams that each sustain the plasma from opposing directions. This configuration allows a further increase in the effective pumping NA of the system, though it requires an increased number of pump laser source and optics, which increases the cost and footprint of the entire LSP light source. For example, system 600 may include a first pump optical assembly 610a and a second pump optical assembly 610b. Each of the first pump optical assembly 610a and 610b may include each of the various components as described with respect to the LSP broadband light source 200. For instance, the first pump optical assembly 610a may include, but is not limited to, pump source 606a, polarization element 612a configured to split the primary beam 608a into a first beam 614a and a second beam 616a, one or more optical elements 618a, and a beam block 619a. In addition, the second pump optical assembly 610b may include, but is not limited to, pump source 606b, polarization element 612b configured to split the primary beam 608b into a first beam 614b and a second beam 616b, one or more optical elements 618b, and a beam block 619b.

FIG. 7 illustrates system 700 including two pairs of symmetrical pump beams, in accordance with one or more alternative and/or additional embodiments of the present disclosure. In this embodiment, the number of pump beam pairs is increased to two by further splitting a single pump beam from a pump laser source into multiple arms by additional polarization manipulation. In this embodiment, multiple polarization elements may be used to generate multiple pairs of orthogonally polarized beams from the pump source that each sustain the plasma from opposing directions. For example, as shown in FIG. 7, a first beamsplitter 709 may split the primary pump beam 708 into a first beam 714 and a second beam 716. The waveplates 701, 703 positioned after the first polarizing beam splitter 709 may be used to rotate the linear polarization states P1, P2 of the two arms by 45° (alternatively, circularly polarized). Then, the two beams 714, 716 are further split into pairs of orthogonal polarization arms by passing through secondary polarization elements 712a, 712b. The four arms of the pump optical assembly 710 may then pass through the gas vessel 702 in two pairs of counter-propagating beams to generate plasma 711, which then trace the other beam’s path back to the secondary polarization elements 712a, 712b and are directed onto beam blocks 719a, 719b placed by the secondary polarization elements. Broadband light 713 may then be collected by the light collector element 715.

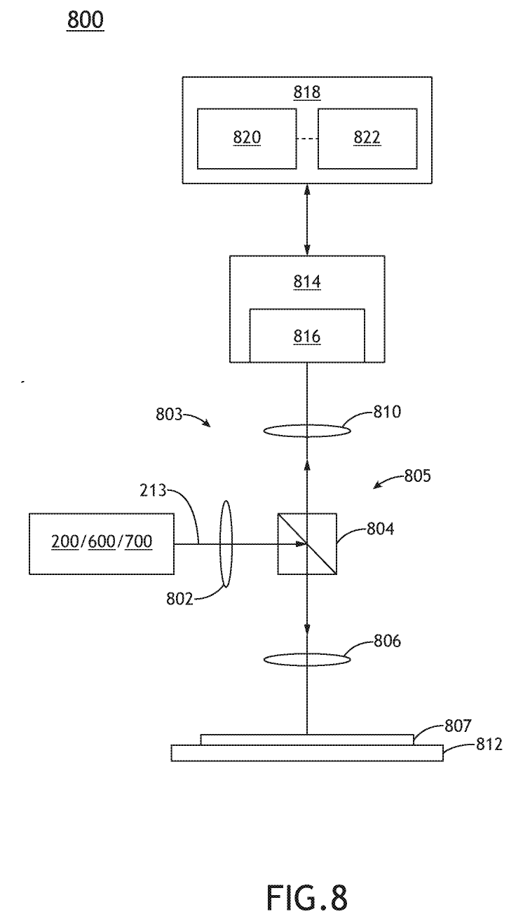

FIG. 8 illustrates a simplified schematic view of an optical characterization system 800 incorporating the LSP broadband light source 200, in accordance with one or more alternative and/or additional embodiments. In embodiments, system 800 includes the LSP light source 200/600/700, an illumination arm 803, a collection arm 805, a detector assembly 814, and a controller 818 including one or more processors 820 and memory 822.

It is noted herein that system 800 may comprise any imaging, inspection, metrology, lithography, or other characterization system known in the art. In this regard, system 800 may be configured to perform inspection, optical metrology, lithography, and/or imaging on a sample 807. Sample 807 may include any sample known in the art including, but not limited to, a wafer, a reticle, a photomask, a flat panel display, and the like. It is noted that system 800 may incorporate one or more of the various embodiments of the LSP broadband light source 200, 600, 700 described throughout the present disclosure.

In embodiments, sample 807 is disposed on a stage assembly 812 to facilitate movement of sample 807. Stage assembly 812 may include any stage assembly 812 known in the art including, but not limited to, an X-Y stage, an R-θ stage, and the like. In embodiments, stage assembly 812 adjusts the height of sample 807 during inspection or imaging to maintain focus on sample 807.

In embodiments, the illumination arm 803 is configured to direct broadband light 213 from the broadband LSP broadband light source 200 to the sample 807. The illumination arm 803 may include any number and type of optical components known in the art. In embodiments, the illumination arm 803 includes one or more optical elements 802, a beam splitter 804, and an objective lens 806. In this regard, illumination arm 803 may be configured to focus broadband light 112 from the broadband LSP light source 100 onto the surface of the sample 807. The one or more optical elements 802 may include any optical element or combination of optical elements known in the art including, but not limited to, one or more mirrors, one or more lenses, one or more polarizers, one or more gratings, one or more filters, one or more beam splitters, and the like. It is noted herein that the collection location may include, but is not limited to, one or more of the optical elements 802, a beam splitter 804, or an objective lens 806.

In embodiments, system 800 includes a collection arm 805 configured to collect light reflected, scattered, diffracted, and/or emitted from sample 807. In another embodiment, collection arm 805 may direct and/or focus the light from the sample 807 to a sensor 816 of a detector assembly 814. It is noted that sensor 816 and detector assembly 814 may include any sensor and detector assembly known in the art. The sensor 816 may include, but is not limited to, a CCD sensor or a CCD-TDI sensor. Further, sensor 816 may include, but is not limited to, a line sensor or an electron-bombardment line sensor.

In embodiments, detector assembly 814 is communicatively coupled to a controller 818 including one or more processors 820 and memory 822. For example, the one or more processors 820 may be communicatively coupled to memory 822, wherein the one or more processors 820 are configured to execute a set of program instructions stored on memory 822. In embodiments, the one or more processors 820 are configured to analyze the output of detector assembly 814. In embodiments, the set of program instructions are configured to cause the one or more processors 820 to analyze one or more characteristics of sample 807. In embodiments, the set of program instructions are configured to cause the one or more processors 820 to modify one or more characteristics of system 800 in order to maintain focus on the sample 807 and/or the sensor 818. For example, the one or more processors 820 may be configured to adjust the objective lens 808 or one or more optical elements 802 in order to focus broadband light 117 from broadband LSP light source 100 onto the surface of the sample 807. By way of another example, the one or more processors 820 may be configured to adjust the objective lens 806 and/or one or more optical elements 810 in order to collect illumination from the surface of the sample 807 and focus the collected illumination on the sensor 816.

Additional details of various embodiments of optical characterization system 800 are described in U.S. Patent No. 7,957,066B2, entitled “Split Field Inspection System Using Small Catadioptric Objectives,” issued on Jun. 7, 2011; U.S. Publication No. 2007/0002465, entitled “Beam Delivery System for Laser Dark-Field Illumination in a Catadioptric Optical System,” published on Jan. 4, 2007; U.S. Patent No. 5,999,310, entitled “Ultra-broadband UV Microscope Imaging System with Wide Range Zoom Capability,” issued on Dec. 7, 1999; U.S. Patent No. 7,525,649, entitled “Surface Inspection System Using Laser Line Illumination with Two Dimensional Imaging,” issued on Apr. 28, 2009; U.S. Patent Publication No. 2013/0114085, entitled “Dynamically Adjustable Semiconductor Metrology System,” by Wang et al. and published on May 9, 2013; U.S. Patent No. 5,608,526, entitled “Focused Beam Spectroscopic Ellipsometry Method and System, by Piwonka-Corle et al., issued on Mar. 4, 1997; and U.S. Patent No. 6,297,880, entitled “Apparatus for Analyzing Multi-Layer Thin Film Stacks on Semiconductors,” by Rosencwaig et al., issued on Oct. 2, 2001, which are each incorporated herein by reference in their entirety.

One skilled in the art will recognize that the herein described components, operations, devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken as limiting.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively "associated" such that the desired functionality is achieved. Hence, any two components herein combined to achieve a particular functionality can be seen as "associated with" each other such that the desired functionality is achieved, irrespective of architectures or intermedial components. Likewise, any two components so associated can also be viewed as being "connected," or "coupled," to each other to achieve the desired functionality, and any two components capable of being so associated can also be viewed as being "couplable," to each other to achieve the desired functionality. Specific examples of couplable include but are not limited to physically mateable and/or physically interacting components and/or wirelessly interactable and/or wirelessly interacting components and/or logically interacting and/or logically interactable components.

Furthermore, it is to be understood that the invention is defined by the appended claims. It will be understood by those within the art that, in general, terms used herein, and especially in the appended claims (e.g., bodies of the appended claims) are generally intended as "open" terms (e.g., the term "including" should be interpreted as "including but not limited to," the term "having" should be interpreted as "having at least," the term "includes" should be interpreted as "includes but is not limited to," and the like). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases "at least one" and "one or more" to introduce claim recitations. However, the use of such phrases should not be construed to imply that the introduction of a claim recitation by the indefinite articles "a" or "an" limits any particular claim containing such introduced claim recitation to inventions containing only one such recitation, even when the same claim includes the introductory phrases "one or more" or "at least one" and indefinite articles such as "a" or "an" (e.g., "a" and/or "an" should typically be interpreted to mean "at least one" or "one or more"); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of "two recitations," without other modifiers, typically means at least two recitations, or two or more recitations). Furthermore, in those instances where a convention analogous to "at least one of A, B, and C, and the like" is used, in general such a construction is intended in the sense one having skill in the art would understand the convention (e.g., "a system having at least one of A, B, and C" would include but not be limited to systems that have A alone, B alone, C alone, A and B together, A and C together, B and C together, and/or A, B, and C together, and the like). In those instances where a convention analogous to "at least one of A, B, or C, and the like" is used, in general such a construction is intended in the sense one having skill in the art would understand the convention (e.g., "a system having at least one of A, B, or C" would include but not be limited to systems that have A alone, B alone, C alone, A and B together, A and C together, B and C together, and/or A, B, and C together, and the like). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase "A or B" will be understood to include the possibilities of "A" or "B" or "A and B."

It is believed that the present disclosure and many of its attendant advantages will be understood by the foregoing description, and it will be apparent that various changes may be made in the form, construction, and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

1. A laser-sustained broadband light source comprising:
a gas vessel configured to contain a gas;
a pump source configured to generate a pump beam;
a pump optical assembly, the pump optical assembly comprising:
a polarization element configured to split the pump beam into a first beam having a first polarization state and a second beam having a second polarization state orthogonal to the first polarization state;
one or more optical elements configured to focus the first beam into the gas vessel along a first propagation direction, wherein the one or more optical elements are configured to focus the second beam into the gas vessel along a second propagation direction opposite the first propagation direction, wherein focal regions of the first and second beams at least partially overlap within the gas vessel to sustain a plasma; and
a beam block positioned to receive the first pump beam and the second pump beam diverted by the polarization element; and
a light collector element configured to collect at least a portion of broadband light emitted from the plasma.

2. The broadband light source of claim 1, wherein the first beam and the second beam have substantially the same intensity.

3. The broadband light source of claim 1, wherein a left-over pump beam from a first arm, after transmission through the plasma, traces the one or more optical elements of a second arm in reverse, and are diverted away from the pump source at the polarization element.

4. The broadband light source of claim 1, wherein the alignment of the first beam and the second beam is adjustable to control a shape and behavior of the plasma.

5. The broadband light source of claim 1, wherein an optical assembly is duplicated around the gas vessel to generate multiple pairs of orthogonally polarized beams that each sustain the plasma from opposing directions.

6. The broadband light source of claim 1, wherein multiple polarization elements are used to generate multiple pairs of orthogonally polarized beams from the pump source that each sustain the plasma from opposing directions.

7. The broadband light source of claim 1, wherein the pump beam is not collinear with a direction of collection of the plasma radiation.

8. The broadband light source of claim 1, wherein the light collector element comprises at least one of a mirror or lens.

9. The broadband light source of claim 8, wherein the light collector element
comprises a reflector assembly.

10. The broadband light source of claim 9, wherein the light collector element comprises an off-axis reflector assembly that collects plasma radiation at a non-collinear angle relative to the pump beam.

11. The broadband light source of claim 9, wherein the light collector element comprises at least one of an elliptical reflector assembly or a spherical reflector assembly.

12. The broadband light source of claim 1, wherein the pump source comprises one or more continuous wave (CW) lasers.

13. A characterization system comprising:
a laser-sustained light source comprising:
a gas vessel configured to contain a gas;
a pump source configured to generate a pump beam;
a pump optical assembly, the pump optical assembly comprising:
a polarization element configured to split the pump beam into a first beam having a first polarization state and a second beam having a second polarization state orthogonal to the first polarization state;
one or more optical elements configured to focus the first beam into the gas vessel along a first propagation direction, wherein the one or more optical elements are configured to focus the second beam into the gas vessel along a second propagation direction opposite the first propagation direction, wherein focal regions of the first and second beams at least partially overlap within the gas vessel to sustain a plasma; and
a beam block positioned to receive the first pump beam and the second pump beam diverted by the polarization element; and
a light collector element configured to collect at least a portion of broadband light emitted from the plasma,
wherein the characterization system further comprises:
a set of illumination optics configured to direct broadband light from the laser-sustained light source to one or more samples;
a set of collection optics configured to collect light emanating from the one or more samples; and
a detector assembly.

14. The system of claim 13, wherein the first beam and the second beam have substantially the same intensity.

15. The system of claim 13, wherein a left-over pump beam of a first, after transmission through the plasma, traces the one or more optical elements of a second arm in reverse, and are diverted away from the pump source at the polarization element.

16. The system of claim 13, wherein the alignment of the first beam and the second beam is adjustable to control a shape and behavior of the plasma.

17. The system of claim 13, wherein an optical assembly is duplicated around the gas vessel to generate multiple pairs of orthogonally polarized beams that each sustain the plasma from opposing directions.

18. The system of claim 13, wherein multiple polarization elements are used to generate multiple pairs of orthogonally polarized beams from the pump source.

19. The system of claim 13, wherein the pump beam is not collinear with a direction of collection of the plasma radiation.

20. The system of claim 13, wherein the light collector element comprises at least one of a mirror or lens.

21. The system of claim 20, wherein the light collector element comprises a reflector assembly.

22. The system of claim 21, wherein the light collector element comprises an off-axis reflector assembly that collects plasma radiation at a non-collinear angle relative to the pump beam.

23. The system of claim 21, wherein the light collector element comprises at least one of an elliptical reflector assembly or a spherical reflector assembly.

24. The system of claim 13, wherein the pump source comprises one or more continuous wave (CW) lasers.

25. A method of generating broadband light comprising:
providing a gas vessel configured to contain a gas;
generating a pump beam;
splitting the pump beam, using a polarization element, into a first beam having a first polarization state and a second beam having a second polarization state orthogonal to the first polarization state;
focusing the first beam into the gas vessel along a first propagation direction;
focusing the second beam into the gas vessel along a second propagation direction opposite the first propagation direction;
wherein focal regions of the first and second beams at least partially overlap within the gas vessel to sustain a plasma;
diverting, with the polarization element, a portion of the first pump beam and a portion of the second pump beam into a beam block; and
collecting at least a portion of broadband light emitted from the plasma.

26. A laser-sustained broadband light source comprising:
a gas vessel configured to contain a gas;
a pump source configured to generate a pump beam;
a pump optical assembly, the pump optical assembly comprising:
a non-polarizing optical element configured to split the pump beam into a first beam and a second beam;
one or more optical elements configured to focus the first beam into the gas vessel along a first propagation direction, wherein the one or more optical elements are configured to focus the second beam into the gas vessel along a second propagation direction opposite the first propagation direction, wherein focal regions of the first and second beams at least partially overlap within the gas vessel to sustain a plasma; and
a beam block positioned to receive a portion of the first pump beam and a portion of the second pump beam diverted by the non-polarizing optical element; and
a light collector element configured to collect at least a portion of broadband light emitted from the plasma.
